(19) United States
(12) Patent Application Publication
(10) Pub. No.: US 2024/0342781 A1
(43) Pub. Date: Oct. 17, 2024

(54) Apparatus for Forming Pouch-Shaped Secondary Battery Case and Forming Method Using the Same

(71) Applicant: LG Energy Solution, Ltd., Seoul (KR)

(72) Inventors: Hui Gyun Nam, Daejeon (KR); Tai Joon Seo, Daejeon (KR); Lae Seo Park, Daejeon (KR)

(73) Assignee: LG Energy Solution, Ltd., Seoul (KR)

(21) Appl. No.: 18/294,016

(22) PCT Filed: Jul. 13, 2023
(86) PCT No.: PCT/KR2023/009988

§ 371 Date: Jan. 31, 2024

(30) Foreign Application Priority Data
Jul. 13, 2022 (KR) 10-2022-0086154

(51) Int. Cl. B21D 22/02; B21D 26/021; G01M 3/32; H01M 50/105

(52) U.S. Cl. CPC B21D 22/02; B21D 26/021; G01M 3/32; H01M 50/105

(57) ABSTRACT

An apparatus for forming a pouch-shaped secondary battery case is provided. The apparatus for forming a pouch-shaped secondary battery case includes a die having a forming recess formed therein, a punch configured to be brought into tight contact with an inner surface of the forming recess while moving upwards and downwards above the die, and a pouch sheet fixing unit configured to fix an edge of the pouch sheet while moving upwards and downwards above the die. The punch is provided with a plurality of air channels configured to blow outside air in a direction toward the forming recess or to suction air. The apparatus is capable of determining whether a pouch sheet is defective and preventing cracks from being formed in a receiving recess. A forming method using the same is also provided.

### CROSS-REFERENCE TO RELATED APPLICATIONS

This application is a national phase entry under 35 U. S. C. § 371 of International Application No. PCT/KR2023/009988 filed on Jul. 13, 2023, which claims the benefit of priority to Korean Patent Application No. 2022-0086154 filed on Jul. 13, 2022, the disclosures of which are incorporated herein by reference in its entirety.

### TECHNICAL FIELD

The present disclosure relates to an apparatus for forming a pouch-shaped secondary battery case and a forming method using the same. More particularly, the present disclosure relates to an apparatus for forming a pouch-shaped secondary battery case capable of determining whether a pouch sheet is defective and preventing cracks from being formed in a receiving recess through processes of changing the movement direction of air using a punch having an air channel formed therein. The present disclosure also relates to a forming method using the same.

### BACKGROUND ART

With the recent development of alternative energies, spurred by the use of fossil fuels which cause air pollution and energy depletion, demand for secondary batteries capable of storing electrical energy has increased. Secondary batteries, which are capable of being charged and discharged, are intimately used in daily life. For example, secondary batteries are used in mobile devices, electric vehicles, and hybrid electric vehicles.

Secondary batteries are classified into can-shaped which a cell assembly battery cells, in constituted by alternately stacked electrodes and separators is mounted in a metal can, and pouch-shaped battery cells, in which a cell assembly constituted by alternately stacked electrodes and separators is mounted in a pouch. The pouch-shaped battery cell has attracted much attention and is increasingly being used due to low manufacturing cost, low weight, and easy deformation.

A pouch-shaped secondary battery is manufactured by forming a pouch sheet (also referred to as an “aluminum laminate sheet”) to form a receiving recess therein, receiving a cell assembly in the receiving recess, and sealing the periphery of the receiving recess.

Meanwhile, cracks and pinholes may be formed during the manufacturing process of the pouch sheet, or various kinds of foreign matter, such as metal particles or dust, may be attached to the pouch sheet during a process of storing or transporting the pouch sheet.

If a pouch-shaped battery cell is manufactured using a sheet having cracks or pinholes formed therein or a sheet having foreign matter attached thereto, moisture or air may permeate the battery cell, or stability and quality of the battery cell may be significantly deteriorated due to the foreign matter.

In addition, a pouch sheet for secondary batteries is formed by pressing a punch into a die having a receiving portion formed therein and, at this time, there is a problem that cracks or wrinkles are formed in the receiving portion of the pouch sheet.

In connection therewith, FIG. 1 discloses a conventional technology for providing an air blowing portion 31 in an upper press 30, blowing air toward an upper surface of a pouch film 10 to bring a part of the pouch film 10 into tight contact with an inner surface of a forming recess 21, and coupling the air blowing portion 31 of the upper press 30 to the forming recess 21, thereby forming the pouch film 10. However, there is a shortcoming in that air must be blown at a considerably high pressure in order to bring the pouch film into tight contact with the forming recess through air blowing.

Furthermore, FIG. 1 does not recognize problems due to defects or contamination of the pouch sheet at all.

### Technical Problem

The present disclosure has been made in view of the above problems, and it is an object of the present disclosure to provide an apparatus for forming a pouch-shaped secondary battery case capable of forming a pouch sheet without blowing air at a high pressure and a forming method using the same.

It is another object of the present disclosure to provide an apparatus for forming a pouch-shaped secondary battery case capable of forming a pouch sheet while detecting defects, such as cracks or pinholes, in the pouch sheet and a forming method using the same.

It is a further object of the present disclosure to provide an apparatus for forming a pouch-shaped secondary battery case capable of minimizing formation of cracks in a receiving recess of a pouch sheet and improving precision of the formed receiving recess, and a forming method using the same.

### Technical Solution

To accomplish the above objects, an apparatus for forming a pouch-shaped secondary battery case according to the present disclosure includes a die (100) having a forming recess (110) formed therein, a punch (200) configured to be brought into tight contact with an inner surface of the forming recess (110) while moving upwards and downwards above the die (100), and a pouch sheet fixing unit (400) configured to fix an edge of a pouch sheet(S) while moving upwards and downwards above the die (100), wherein the punch (200) is provided with a plurality of air channels (210) configured to blow outside air in a direction toward the forming recess (110) or to suction air.

Also, in the apparatus for forming the pouch-shaped secondary battery case according to the present disclosure, the air channels (210) may include a first air channel (211) located in the vicinity of an edge of the punch (200) and a second air channel (212) located inside the first air channel (211).

Also, in the apparatus for forming the pouch-shaped secondary battery case according to the present disclosure, the first air channel (211) may be inclined so as to face a die edge portion (120) of the forming recess (110).

Also, the apparatus for forming the pouch-shaped secondary battery case according to the present disclosure may further include an air conduit (300) having one side connected to the air channels (210) and the other side extending out of the punch (200).

Also, in the apparatus for forming the pouch-shaped secondary battery case according to the present disclosure, at least one of a pressure gauge and a flow meter may be provided in the air conduit (300).

Also, in the apparatus for forming the pouch-shaped secondary battery case according to the present disclosure, the air conduit (300) may include a first air conduit (310) connected to the first air channel (211) and a second air conduit (320) connected to the second air channel (212).

Also, in the apparatus for forming the pouch-shaped secondary battery case according to the present disclosure, each of the first air conduit (310) and the second air conduit (320) may be provided with an opening and closing valve configured to control movement of air.

In addition, the present disclosure provides a method of forming a pouch sheet using the apparatus for forming the pouch-shaped secondary battery case, the method including a first step of seating a pouch sheet(S) on the die (100) having the forming recess (110) formed therein, a second step of fixing an edge of the pouch sheet(S), a third step of downwardly moving the punch (200) to a predetermined height from an upper surface of the pouch sheet(S) and reducing the pressure of the air channels (210) in the punch (200) to suction foreign matter from the pouch sheet(S) such that the foreign matter is removed, a fourth step of bringing the punch (200) into contact with the upper surface of the pouch sheet(S) and reducing the pressure of the air channels (210), and a fifth step of downwardly moving the punch (200) so as to come into tight contact with the inner surface of the forming recess (110) while maintaining a depressurized state of the air channels (210).

Also, in the method of forming the pouch sheet according to the present disclosure, in the third step, air may be blown through a first air channel (211) located in the vicinity of the edge of the punch (200), the pressure of the second air channel (212) located inside the first air channel (211) may be reduced.

Also, in the method of forming the pouch sheet according to the present disclosure, the fourth step may further include maintaining a depressurized state for a predetermined period of time to determine the presence of cracks or pinholes in the pouch sheet(S).

Also, in the method of forming the pouch sheet according to the present disclosure, the presence of cracks or pinholes may be determined based on a change in pressure or a change in flow rate.

Also, the method of forming the pouch sheet according to the present disclosure may further include a sixth step of blowing air through the air channels (210) in a direction toward the forming recess (110) after the punch (200) comes into tight contact with the inner surface of the forming recess (110).

Also, in the method of forming the pouch sheet according to the present disclosure, in the sixth step, the pressure or flow rate of air blown through the first air channel (211), located in the vicinity of the edge of the punch (200), may be maintained so as to be higher than the pressure or flow rate of air blown through the second air channel (212), located inside the first air channel (211).

### Advantageous Effects

As is apparent from the above description, an apparatus for forming a pouch-shaped secondary battery case according to the present disclosure, and a forming method using the same, have an advantage in that a punch having an air channel formed therein and a pouch sheet are brought into tight contact with each other, a change in pressure or a change in flow rate is checked while a depressurized state is maintained for a predetermined period of time, whereby it is possible to determine whether cracks or pinholes are present in the pouch sheet. Accordingly, it is possible to improve process efficiency.

In addition, the apparatus for forming the pouch-shaped secondary battery case according to the present disclosure, and the forming method using the same, have merit in that the movement direction of air is controlled through the air channel provided in the punch, whereby it is possible to prevent formation of cracks during a forming process and furthermore to form a uniform receiving recess.

### DESCRIPTION OF DRAWINGS

FIG. 1 is a sectional view of a conventional forming apparatus.

FIG. 2 is a sectional view of an apparatus for forming a pouch-shaped secondary battery case according to a first preferred embodiment of the present invention.

FIG. 3 is a plan view of the forming apparatus taken along line A-A of FIG. 2.

FIG. 4 is a sectional view of an apparatus for forming a pouch-shaped secondary battery case according to a second preferred embodiment of the present invention.

FIG. 5 is a sectional view of an apparatus for forming a pouch-shaped secondary battery case according to a third preferred embodiment of the present invention.

FIG. 6 is a flowchart illustrating a forming method using the forming apparatus according to the first preferred embodiment of the present invention.

FIG. 7 is a flowchart illustrating a forming method using the forming apparatus according to the third preferred embodiment of the present invention.

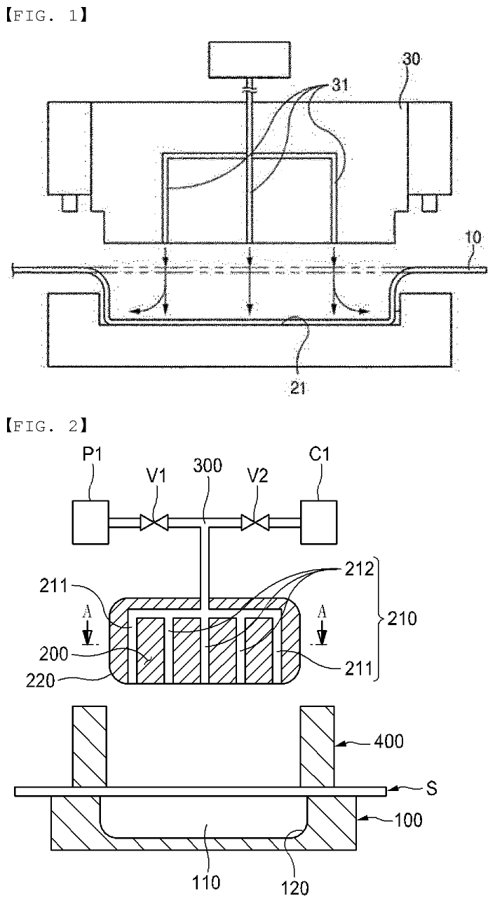

### DETAILED DESCRIPTION

Now, preferred embodiments of the present invention will be described in detail with reference to the accompanying drawings such that the preferred embodiments of the present invention can be easily implemented by a person having ordinary skill in the art to which the present disclosure pertains. In describing the principle of operation of the preferred embodiments of the present invention in detail, however, a detailed description of known functions and configurations incorporated herein will be omitted when the same may obscure the subject matter of the present disclosure.

In addition, the same reference numbers will be used throughout the drawings to refer to parts that perform similar functions or operations. In the case in which one part is said to be connected to another part in the entire specification, not only may the one part be directly connected to the other part, but also, the one part may be indirectly connected to the other part via a further part. In addition, that a certain element is included does not mean that other elements are excluded, but means that such elements may be further included unless mentioned otherwise.

Hereinafter, an apparatus for forming a pouch-shaped secondary battery case according to the present disclosure and a forming method using the same will be described with reference to the accompanying drawings.

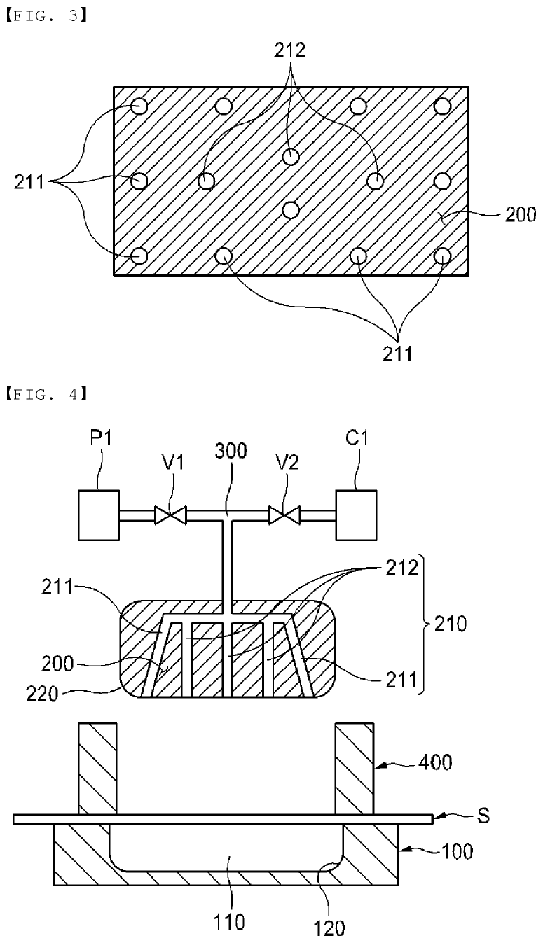

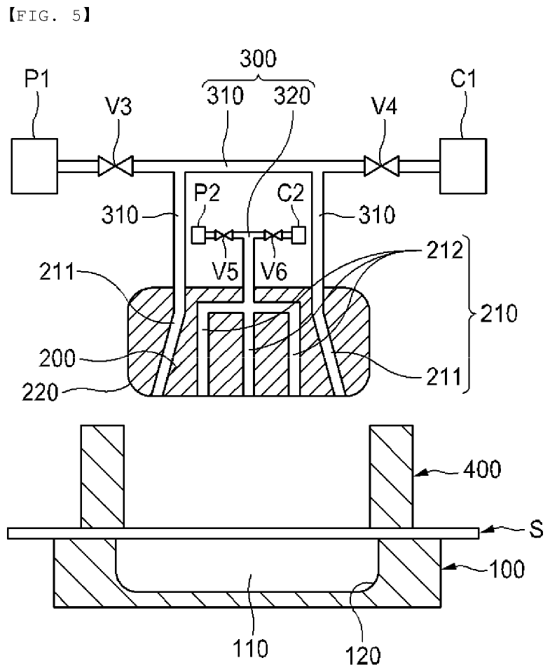

FIG. 2 is a sectional view of an apparatus for forming a pouch-shaped secondary battery case according to a first preferred embodiment of the present invention, and FIG. 3 is a plan view of the forming apparatus taken along line A-A of FIG. 2.

As shown in FIGS. 2 and 3, the forming apparatus according to the first preferred embodiment of the present invention includes a die 100, a punch 200, an air conduit 300, and a pouch sheet fixing unit 400.

First, the die 100 is provided with a forming recess 110 formed in a shape corresponding to a receiving recess configured to receive an electrode assembly, and a die edge portion 120 having a predetermined radius of curvature is located along an edge at which a bottom surface and a vertical surface of the forming recess 110 join each other.

The punch 200, which is identical in outer shape to the forming recess 110, is operated to move upwards and downwards above the die 100. When a pouch sheet S is located between the die 100 and the punch 200, and the punch 200 is moved downwards, the punch comes into tight contact with an inner surface of the forming recess 110, whereby a receiving recess is formed in the pouch sheet S.

Meanwhile, the punch 200 is provided with a plurality of air channels 210. More specifically, the air channels 210 may include first air channels 211 and second air channels 212 located perpendicular to the bottom surface of the forming recess 110, wherein the first air channels 211 are located in the vicinity of an edge of the punch 200 while the second air channels 212 are located inside the first air channels 211.

The first air channels 211 and the second air channels 212 are paths through which air moves, and outside air introduced through the air conduit 300 may be blown toward the forming recess 110, or conversely, air from below may be introduced and may then be discharged through the air conduit 300.

It is possible to remove foreign matter from the top of the pouch sheet S and to determine the presence of cracks or pinholes in the pouch sheet S by utilizing the first air channels 211 and the second air channels 212. Furthermore, it is ensured that a bottom surface, a side surface, and a bent portion of the receiving recess of the pouch sheet S are smooth flat or curved surfaces, which will be described in detail later.

Although the number of the first air channels 211 and the second air channels 212 are shown as being 10 and 4, respectively, the figure is only an example, and the number of the first air channels and the second air channels may be changed.

Next, the air conduit 300 will be described. As described above, the air conduit 300 is configured to supply air to the air channels 210, more specifically to the first air channels 211 and the second air channels 212, and to discharge the air suctioned into the first air channels 211 and the second air channels 212 to the outside.

Consequently, the air conduit 300 has one side connected to the punch 200 and the other side extending out of the punch 200 so as to communicate with the first air channels 211 and the second air channels 212.

Here, the air conduit 300 is formed so as to face in three directions, one of which is connected to the punch 200, and the other two are connected to a first pressure reducing pump P1 and a first compressor C1. In addition, a first valve V1 and a second valve V2, configured to control the flow direction of air, are provided in the vicinity of the first pressure reducing pump P1 and the first compressor C1, respectively. Furthermore, it is preferable for at least one of a flow meter (not shown) and a pressure gauge (not shown) to be further provided in the air conduit 300 in order to check the flow rate or the pressure of air passing through the air conduit 300.

For example, the flow meter, the pressure gauge, or the flow meter and the pressure gauge, may be installed between the first pressure reducing pump P1 and the first valve V1 and between the first compressor C1 and the second valve V2; however, the installation positions are not particularly restricted as long as it is possible to measure the flow rate or the pressure of air.

Meanwhile, the pressure reducing pump is configured to form negative pressure in the air channels, and the pressure reducing pump is not necessarily used. Any other means may be used as long as it is possible to perform the same function. In addition, the compressor is configured to supply air to the air channels, and the compressor is not necessarily used. Any other means may be used as long as it is possible to perform the same function.

The pouch sheet fixing unit 400 is configured to fix an edge of the pouch sheet S while moving upwards and downwards above the die 100. Although not shown in the figures, a lifting means may be further provided at the pouch sheet fixing unit 400.

FIG. 4 is a sectional view of an apparatus for forming a pouch-shaped secondary battery case according to a second preferred embodiment of the present invention. Referring to FIG. 4, this embodiment is identical in construction to the first embodiment except for the shape of air channels 210, and therefore only the different construction will be described.

In the forming apparatus according to the second embodiment of the present invention, the air channels 210 are constituted by first air channels 211 and second air channels 212, which are inclined such that air can be directed to a die edge portion 120, whereby openings of the first air channels 211 are located in the vicinity of the die edge portion 120.

When air blown from the first air channels 211 is directed toward the die edge portion 120, as described above, it is possible to more easily form a bent portion of a pouch sheet S, which is relatively difficult to form, and to form the bent portion so as to have a smooth curved surface.

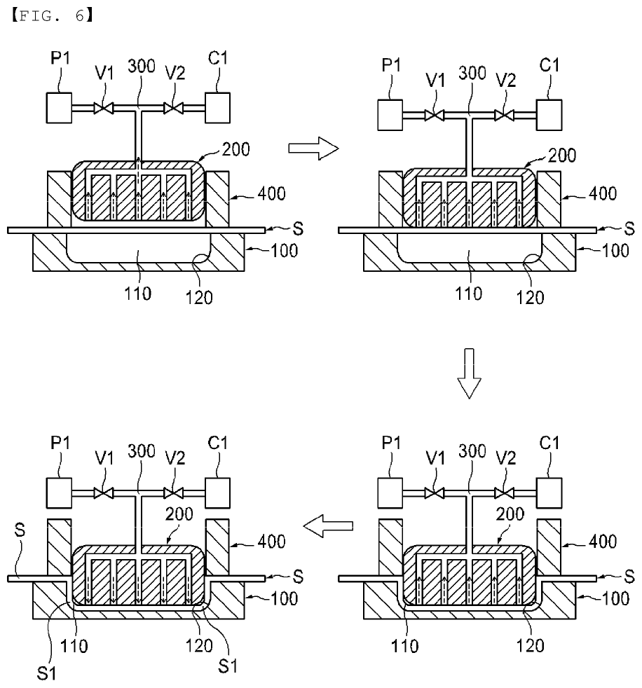

FIG. 5 is a sectional view of an apparatus for forming a pouch-shaped secondary battery case according to a third preferred embodiment of the present invention.

Referring to FIG. 5, this embodiment is identical in construction to the first embodiment except for the construction of air channels 210 and an air conduit 300, and therefore only the different construction will be described.

In the forming apparatus according to the third embodiment of the present invention, air channels 210 are constituted by first air channels 211 and second air channels 212, which are inclined such that air can be directed to a die edge portion 120, as in the second embodiment, whereby openings of the first air channels 211 are located in the vicinity of the die edge portion 120.

Meanwhile, the air conduit 300 includes a first air conduit 310 connected to the first air channels 211 and a second air conduit 320 connected to the second air channels 212. The first air conduit 310 is provided with a first pressure reducing pump P1 and a first compressor C1, and the second air conduit 320 is provided with a second pressure reducing pump P2 and a second compressor C2, whereby it is possible to individually control the supply or discharge of air to or from the air conduits. Of course, a third valve V3 and a fourth valve V4 are mounted to the first air conduit 310, and a fifth valve V5 and a sixth valve V6 are mounted to the second air conduit 320.

Also, in order to individually check the flow rate or the pressure of air passing through the first air conduit 310 and the second air conduit 320, at least one of a flow meter (not shown) and a pressure gauge (not shown) is provided in each of the conduits, in the same manner as in the first embodiment.

When the first air conduit 310 and the second air conduit 320 are provided in a state of being separated from each other such that air can be supplied to or discharged from each of the first air channels 211 and the second air channels 212, as described above, it is possible to more easily remove foreign matter from a pouch sheet S, which will be described in more detail later.

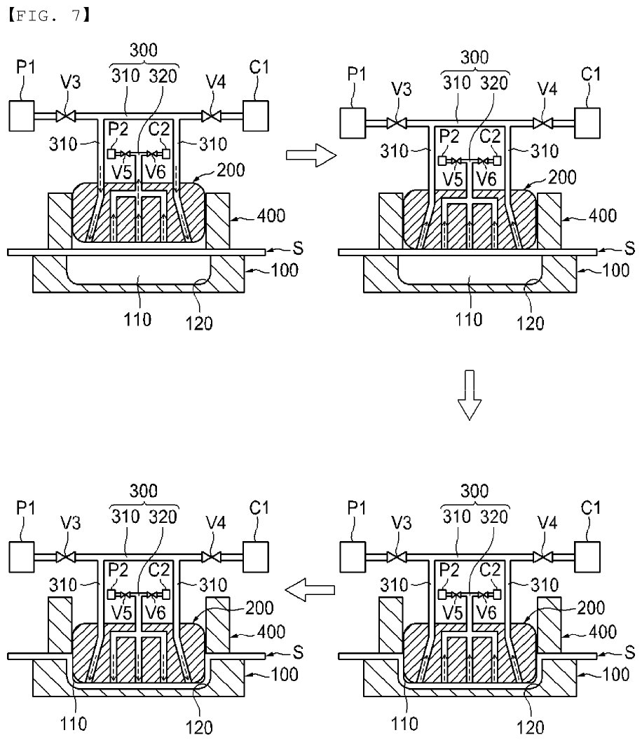

FIG. 6 is a flowchart illustrating a forming method using the forming apparatus according to the first preferred embodiment of the present invention.

The forming method using the forming apparatus according to the first embodiment may include a first step of seating a pouch sheet S on the die 100 having the forming recess 110 formed therein, a second step of fixing an edge of the pouch sheet S, a third step of downwardly moving the punch 200 to a predetermined height from an upper surface of the seated pouch sheet S and reducing the pressure of the air channels in the punch 200 to suction foreign matter on the upper surface of the pouch sheet S such that the foreign matter is removed, a fourth step of bringing the punch 200 into contact with the upper surface of the pouch sheet S and reducing the pressure of the air channels, a fifth step of downwardly moving the punch 200 so as to come into tight contact with the inner surface of the forming recess 110 while maintaining the depressurized state of the air channels, and a sixth step of blowing air through the air channels in a direction toward the forming recess 110.

Specifically, the first step is a step of locating a pouch sheet S cut to a predetermined size on the die 100, and the second step is a step of downwardly moving the pouch sheet fixing unit 400 to securely press an edge of the pouch sheet S such that the edge of the pouch sheet is fixed in order to maintain the fixed state of the pouch sheet S even though the punch 200 moves to the forming recess 110.

Here, an inner vertical surface of the pouch sheet fixing unit 400 is preferably located on the same vertical extension line as a vertical wall surface forming the forming recess 110 of the die 100.

The third step is a step of removing various kinds of foreign matter settled on or attached to the pouch sheet S during a process of manufacturing or transporting the pouch sheet S. That is, the punch 200 is moved downwards such that the distance from the upper surface of the pouch sheet S is a few centimeters or less, preferably 2 centimeters or less, and air in the vicinity of the upper surface of the pouch sheet S is suctioned to remove the foreign matter. At this time, the first valve V1 of the air conduit 300 connected to the first pressure reducing pump P1 is open, whereas the second valve V2 of the air conduit 300 connected to the first compressor C1 is closed.

The fourth step is a step of determining the presence of cracks or pinholes formed during the process of manufacturing or transporting the pouch sheet S. Specifically, the punch 200 is moved downwards such that the upper surface of the pouch sheet S and the lower surface of the punch 200 come into tight contact with each other, the first valve V1 of the air conduit 300 connected to the first pressure reducing pump P1 is opened and the second valve V2 of the air conduit 300 connected to the first compressor C1 is closed.

At this time, when there are no cracks or pinholes in the pouch sheet S, the suction pressure or the air flow rate of the air conduit 300 connected to the first pressure reducing pump P1 or the first compressor C1, respectively, does not change, but when there are cracks or pinholes, the suction pressure or the air flow rate changes, whereby it is possible to determine whether cracks or pinholes have been formed.

The fifth step is a step of bringing the punch 200 into tight contact with the inner surface of the forming recess 110 in order to form a receiving recess in the pouch sheet S. At this time, the second valve V2 of the air conduit 300 connected to the first compressor C1 is closed and the first valve V1 of the air conduit 300 connected to the first pressure reducing pump P1 is opened such that the pouch sheet S is shaped in a state of being in tight contact with the punch 200.

The sixth step is a step of blowing air in the direction toward the forming recess 110, which is a kind of forming finishing step. Although the receiving recess is formed in the pouch sheet S in the fifth step in which the outer surface of the punch 200 and the inner surface of the forming recess 110 come into tight contact with each other, a part of the receiving recess may not form a smooth surface. When the step of blowing air in the direction toward the forming recess 110 is performed, however, the surface of the receiving recess may be smoothly finished due to the pressure of the blown air.

Meanwhile, a forming method using the forming apparatus according to the second embodiment of the present invention is identical to the forming method using the forming apparatus according to the first embodiment. However, the forming apparatus according to the second embodiment has an advantage in that the openings of the first air channels 211 are located in the vicinity of the die edge portion 120, and therefore, smooth finish can be achieved on the curved surface of the bent portion of the pouch sheet S, which is relatively difficult to form.

FIG. 7 is a flowchart illustrating a forming method using the forming apparatus according to the third preferred embodiment of the present invention.

A first step of seating a pouch sheet S on the die 100 having the forming recess 110 formed therein and a second step of fixing an edge of the pouch sheet S are identical to the steps of the forming method according to the first embodiment.

In a third step, however, the punch 200 is moved downwards to a predetermined height from an upper surface of the seated pouch sheet S, air is supplied to the first air channels 211 in the punch 200, and the pressure of the second air channels 212 is reduced to a negative pressure in order to suction foreign matter on the upper surface of the pouch sheet S such that the foreign matter can be removed.

That is, the fourth valve V4 of the first air conduit 310 connected to the first compressor C1 is open, but the third valve V3 is closed. In addition, the fifth valve V5 of the second air conduit 320 connected to the second pressure reducing pump P2 is open. Of course, the sixth valve V6 of the second air conduit 320 connected to the second compressor C2 is closed.

When the foreign matter on the pouch sheet S is far from the openings of the second air channels 212, it may be difficult to suction the foreign matter. Since air is blown through the first air channels 211 provided along the edge of the punch 200 and is suctioned through the second air channels 212, however, the foreign matter may be well suctioned into the second air channels 212.

A fourth step of bringing the punch 200 into contact with the upper surface of the pouch sheet S and reducing the pressure of the air channels 210, a fifth step of downwardly moving the punch 200 so as to come into tight contact with the inner surface of the forming recess 110 while maintaining the depressurized state of the air channels, and a sixth step of blowing air through the air channels 210 in a direction toward the forming recess 110 are substantially identical to the steps of the forming method according to the first embodiment.

Since the forming apparatus according to the third embodiment is used, however, the first compressor C1 and the first pressure reducing pump P1 are used in order to supply air to the first air conduit 310 or to reduce the pressure of the first air conduit, and the second compressor C2 and the second pressure reducing pump P2 are used in order to supply air to the second air conduit 320 or to reduce the pressure of the second air conduit.

Meanwhile, air from the first compressor C1 and the second compressor C2, which are driven separately, is supplied to the first air conduit 310 and the second air conduit 320, respectively, and therefore it is easier to supply relatively high-pressure air toward the curved surface of the bent portion of the pouch sheet S, which is difficult to form.

The present disclosure has been described above with reference to specific embodiments. However, based on the above description, those skilled in the art to which the present disclosure pertains will appreciate that various applications and modifications are possible within the category of the present disclosure.

### DESCRIPTION OF REFERENCE SYMBOLS

100: Die
110: Forming recess
120: Die edge portion
200: Punch
210: Air channel
211: First air channel
212: Second air channel
220: Punch edge portion
300: Air conduit
310: First air conduit
320: Second air conduit
400: Pouch sheet fixing unit
S: Pouch sheet
S1: Bent portion
P1: First pressure reducing pump
P2: Second pressure reducing pump
C1: First compressor
C2: Second compressor
V1: First valve
V2: Second valve
V3: Third valve
V4: Fourth valve

1. An apparatus for forming a pouch-shaped secondary battery case, comprising:
a die having a forming recess formed therein;
a punch configured to be brought into tight contact with an inner surface of the forming recess while moving upwards and downwards above the die; and
a pouch sheet fixing unit configured to fix an edge of a pouch sheet while moving upwards and downwards above the die, wherein:
the punch has a plurality of air channels configured to blow outside air in a direction toward the forming recess or to suction air.

2. The apparatus according to claim 1, wherein the air channels comprise:
a first air channel located in a vicinity of an edge of the punch; and
a second air channel located inside the first air channel.

3. The apparatus according to claim 2, wherein the first air channel is inclined so as to face a die edge portion of the forming recess.

4. The apparatus according to claim 2, further comprising an air conduit having one side connected to the air channels and the other side extending out of the punch.

5. The apparatus according to claim 4, wherein at least one of a pressure gauge or a flow meter is provided in the air conduit.

6. The apparatus according to claim 4, wherein the air conduit comprises:
a first air conduit connected to the first air channel; and
a second air conduit connected to the second air channel.

7. The apparatus according to claim 6, wherein each of the first air conduit and the second air conduit is provided with an opening and closing valve configured to control movement of air.

8. A method of forming a pouch sheet using the apparatus according to claim 1, the method comprising:
a first step of seating a pouch sheet on the die having the forming recess formed therein;
a second step of fixing an edge of the pouch sheet;
a third step of downwardly moving the punch to a predetermined height from an upper surface of the pouch sheet and reducing a pressure of the air channels in the punch to suction foreign matter from the pouch sheet to remove the foreign matter;
a fourth step of bringing the punch into contact with the upper surface of the pouch sheet and reducing the pressure of the air channels; and
a fifth step of downwardly moving the punch so as to come into tight contact with the inner surface of the forming recess while maintaining a depressurized state of the air channels.

9. The method according to claim 8, wherein, in the third step, air is blown through the first air channel located in the vicinity of the edge of the punch and a pressure of the second air channel located inside the first air channel is reduced.

10. The method according to claim 8, wherein the fourth step further comprises maintaining a depressurized state for a predetermined period of time to determine a presence of cracks or pinholes in the pouch sheet.

11. The method according to claim 10, wherein the presence of cracks or pinholes is determined based on a change in pressure or a change in flow rate.

12. The method according to claim 8, further comprising a sixth step of blowing air through the air channels in a direction toward the forming recess after the punch comes into tight contact with the inner surface of the forming recess.

13. The method according to claim 12, wherein, in the sixth step, a pressure or flow rate of air blown through the first air channel located in the vicinity of the edge of the punch is maintained so as to be higher than a pressure or flow rate of air blown through the second air channel located inside the first air channel.
